(19) United States
(12) Patent Application Publication
(10) Pub. No.: US 2020/0076185 A1
(43) Pub. Date: Mar. 5, 2020

(54) INRUSH CURRENT LIMITING DEVICE AND POWER FACTOR CORRECTION CIRCUIT

(71) Applicant: FRIWO Gerätebau GmbH, Ostbevern (DE)

(72) Inventor: Daniel Wissing, Greven (DE)

(21) Appl. No.: 16/553,477

(22) Filed: Aug. 28, 2019

(30) Foreign Application Priority Data
Aug. 29, 2018 (EP) 18191477.1

(51) Int. Cl. H02H 9/00; H02M 1/32; H02M 1/42; H02M 3/07; H02M 7/12

(52) U.S. Cl. CPC H02H 9/001; H02M 1/32; H02M 7/12; H02M 3/07; H02M 1/42

(57) ABSTRACT

An inrush current limiting device and to a power factor correction circuit including an inrush current limiter. In particular, the application relates to a power factor correction circuit for controlling an inrush current limiter in a power conversion system used as a power supply. An inrush current limiting device for limiting inrushing current to a connectable load includes a first node and a second node, a resistive limiter unit for limiting current flowing through said limiter unit from said first to said second node, and a controllable bridging device which is connected between said first and said second nodes in parallel to the limiter unit, wherein the bridging device includes a semiconductor switch and a charge pump circuit connected to a control terminal of the semiconductor switch for controlling the semiconductor switch.

### FIELD

Embodiments relate to an inrush current limiting device and to a power factor correction circuit including an inrush current limiter. In particular, embodiments relate to a power factor correction circuit for controlling an inrush current limiter in a power conversion system used as a power supply.

### SUMMARY

Power supplies connected to an AC line voltage supply are often subjected to short-duration, high amplitude input current (known as inrush current). Generally, high inrush currents occur when many items of electrical equipment such as switched mode power supplies, motors, transformers and amplifiers are turned on. These currents can damage individual components or entire subassemblies and blow fuses in error. Such high currents are caused by the extremely low impedance of smoothing capacitors or coils which almost produce short circuits at the moment of switching on.

The inrush current may be many times the steady-state current until the power supply reaches equilibrium, i. e. the transient effect continues until the voltage across the internal power supply capacitance reaches a voltage approximately equal to the peak amplitude of the AC line voltage supply. If uncontrolled, the inrush current can result in the internal power supply capacitance absorbing energy beyond its rated value as well as subjecting power supply components to damaging current levels. Furthermore, these inrush currents can also cause interferences to the equipment and apparatus connected to the power supply.

It is known by those skilled in the art that inrush current can be reduced, i. e. limited, when the supply is switched on by introducing a resistive element or defiance in one or more of the supply lines between the input lines and an output capacitor off the power supply. Therefore, by limiting the inrush current the input components avoid being overstressed and any interference is reduced. It is further known that resistors or NTC thermistors, for example, can be used to limit inrush current.

Furthermore, it is known to those skilled in the art of power conversion that market interests, which are driven by legislation and/or formal standards, have over recent years been directed to power factor correction (PFC). The power factor (PF) is defined as PF=R/S, where R is the real power and S is the total apparent power. PFC is used as a means for pre-regulating the input power, while at the same time boosting the output DC voltage, such that it has an improved PF before the power is converted by a power converter.

However, known inrush current limiters have high losses during normal operation off the power supply and, furthermore, may negatively influence any surge tests. In order to avoid such losses, it is known to use a relay for bypassing the inrush current limit during normal operation. Such relays, however need a lot of board space, are expensive, and requires a relatively high switching power. This enhances the open circuit losses.

The object underlying the application is to provide an effective inrush current limiting device and a power factor correction circuit which alleviate or overcome the above disadvantages and provide a significant reduction of manufacturing costs and the complexity.

This object is solved by the subject matter of the independent claims. Advantageous embodiments of the application are the subject matter of the dependent claims.

Embodiments are based on the idea that using a bridging device based on a semiconductor switch allows dispensing with a relay. According to the application, the semiconductor switch is controlled by a charge pump circuit. Thus, the circuitry can be fabricated much smaller and may also be realized in surface mount device (SMD) assembly technique. Because no relay is used, no audible clicking or other sounds occur. The no-load energy losses are reduced compared to circuits where the inrush current limited is bridge by a relay. Finally, the losses off the power supply in normal operation are reduced.

In particular, an inrush current limiting device for limiting inrushing current to a connectable load includes a first node and a second node, a resistive limiter unit for limiting current flowing through said limiter unit from said first to said second node, and a controllable bridging device which is connected between said first and said second nodes in parallel to the limiter unit. According to the application, the bridging device includes a semiconductor switch and a charge pump circuit connected to a control terminal of the semiconductor switch for controlling the semiconductor switch.

According to an advantageous embodiment of the application, the limiter unit includes a resistor with negative temperature coefficient (NTC).

NTC thermistors acting as inrush current limiters limit the current without elaborate circuitry at low cost. Advantageously, the resistance of negative temperature coefficient (NTC) thermistors falls as their temperature rises. In the cold state, i.e. at room temperature, the high initial resistance of the inrush current limiter effectively absorbs the power of peak inrush currents. As a result of the current load and subsequent heating, the resistance of the inrush current limiter then drops by a factor >30-50 to a few percent of its value at room temperature. The power consumption of the inrush current limiters is thus very low in continuous operation—an outstanding advantage of NTC thermistors over fixed resistors.

After a load has been switched off, the NTC thermistor must be allowed to cool down to room temperature if its capacity for inrush current limiting is to be fully used. This can take from 30 seconds to two minutes depending on the disk size. In the case of switched mode power supplies, these cooling times are often a minor consideration because electrolytic capacitors in the circuit usually take longer to discharge fully. The NTC thermistor will therefore be cool enough to resume operation in the event of another short-term turn-on.

NTC thermistors are usually made from various metal oxides that are combined into a powdery mass and mixed with a plastic binding agent. In the production of inrush current limiters, the mass is pressed into disks under high pressure. Polycrystalline NTC thermistor bodies are formed by subsequent sintering of these blanks at temperatures between 1000 and 1400° C. A silver paste is baked onto them as metallization on both sides. The disks are then leaded and sealed in varnish. It is, however, clear for a person skilled in the art that any other assembly technique and realization may also be employed for providing a resistive limiter unit according to the application.

According to an advantageous embodiment, said semiconductor switch is a bypass transistor which includes a power MOSFET, wherein a drain terminal of the MOSFET is connected to the first node, a source terminal of the MOSFET is connected to the second node, and a gate terminal of the MOSFET forming said control terminal is connected to said charge pump circuit. In particular, a power MOSFET with a rating of 500 V to 1000 V can be used. Advantageously, the resistance in the conductive state is very low, for instance, Rds_on may be below 600 mΩ.

According to a further advantageous embodiment, said charge pump circuit includes a charge pump capacitor, which is connected with a first end via a first diode to an auxiliary voltage, and is further connected with said first end to the gate terminal of the bypass transistor. A low component expense and complexity can be achieved when using a supply voltage that is already present in the circuitry. The auxiliary voltage may for instance be a positive supply voltage Vcc of an integrated circuit including the inrush current limiting device. The auxiliary voltage does not have to be extremely precise in its value and may for instance be between 10 V and 20 V.

In order to ensure that the semiconductor switch remains constantly on when the bridging function is required, a low pass filter is arranged between said second node and said gate terminal.

Furthermore, a current limiting resistor may be arranged between said gate terminal and said charge pump circuit in order to limit the current through the charge pump circuit.

According to a further advantageous embodiment of the application, a Zener diode is connected between said gate terminal and said second node for protecting the semiconductor switch.

The application further relates to an active power factor correction (PFC) circuit including an input terminal which is connectable to a power source, an output terminal which is connectable to a load, a PFC choke connected to said input terminal, a PFC diode connected in series with said PFC choke, an inrush diode connected in parallel to the series connection of the PFC choke and the PFC diode, and a PFC switch connected between said PFC choke and a reference potential to form a boost converter, and an inrush current limiting device, which is connected between said PFC diode and the output terminal.

As mentioned above, PFC is a technique of increasing the power factor of a power supply. Switching power supplies without power factor correction draw current in short, high-magnitude pulses. These pulses can be smoothed out by using active or passive techniques. This reduces the input RMS current and apparent input power, thereby increasing the power factor.

The power factor correction shapes the input current in order to maximize the real power from the AC supply. Ideally, electrical equipment should present a load that emulates a pure resistor, meaning that the reactive power would be zero. And the current and voltage waveforms would be the same sine wave and in phase with one another. However, due to the reactive components in a majority of circuits, there is always a power lag that leads to lower power factors.

In an ideal system, all the power drawn from the AC mains is utilized in doing useful work. This is only possible when the current is in phase with the voltage. When the phase between the two varies, some of the energy from the AC outlet does not perform useful work and is lost.

Power factor correction tries to push the power factor of the electrical system such as the power supply towards 1, and even though it does not reach this it gets to as close as 0.95 which is acceptable for most applications. There are two common types of power factor correction for power supplies; the passive PFC and the active PFC. The passive PFCs are simple, robust and reliable for lower power requirements. In addition, they do not generate EMI. However, they are big and heavy due to the inductor. The active PFC methods are preferred for power supplies of over 100 W. This method provides a more efficient correction, is lighter and less bulky.

A basic active PFC circuit consists of a control circuit that measures the input voltage and current and then adjusts the switching time and duty cycle to ensure that the input voltage and current are in phase. This provides an automatic correction of the input AC voltage, resulting to a theoretical power factor of over 0.95. Unlike the passive PFC, the active PFC operates over a wide range of input voltages. However, it requires extra components, which makes it more complex and expensive.

In summary, with a power factor equal to 1 or as close as possible, there are lower losses and all power generated is utilized efficiently.

The technical benefits are improved efficiency and reduction in power demand, hence a reduction in the load on the switching gear and cables, reduced costs to the consumer and support for more load.

According to the application, the inrush current limiting device includes a first node and a second node, a resistive limiter unit for limiting current flowing through said limiter unit from said first to said second node, and a controllable bridging device which is connected between said first and said second nodes in parallel to the limiter unit, wherein the bridging device includes a semiconductor switch, preferably a bypass transistor, and a charge pump circuit connected to a gate terminal of the semiconductor switch for controlling the semiconductor switch.

Advantageously, the limiter unit includes a resistor with negative temperature coefficient (NTC).

According to another advantageous embodiment, the charge pump is connected between the PFC switch and the PFC choke, and is connected to the bridging device for providing a boosted control voltage.

Further, the power factor correction circuit may include a bulk capacitor connected in series with said limiter unit. This capacitor causes inrush currents when being charged. Hence, the bridging semiconductor switch needs to block the bypass path while the bulk capacitor is charged.

According to an advantageous embodiment of the application, said charge pump is operable to provide a boosted control voltage that equals to a sum of a voltage across said bulk capacitor and a voltage across said PFC switch. Thus, in a particularly effective manner, the resistive limiter unit can be bypassed when the PFC stage is active. When the PFC stage is inactive, the bypass is removed.

According to an advantageous embodiment, said semiconductor switch is a bypass transistor which includes a power MOSFET, wherein a drain terminal of the MOSFET is connected to the first node, a source terminal of the MOSFET is connected to the second node, and a gate terminal of the MOSFET forming the control terminal is connected to said charge pump circuit. However, it is apparent to a person skilled in the art that other suitable semiconductor switches, for instance an SiC MOSFET or a thyristor, may also be used.

Advantageously, said charge pump circuit may includes a charge pump capacitor, which is connected with a first end via a first diode to an auxiliary voltage, and is further connected with said first end to the gate terminal of the bypass transistor. As mentioned above, the auxiliary voltage may be a positive supply voltage Vcc of an integrated circuit including the inrush current limiting device. The auxiliary voltage does not have to be extremely precise in its value and may for instance be between 10 V and 20 V. The charge pump capacitor may for instance have capacitance values of around 10 nF.

As mentioned above, a low pass filter may be arranged between said second node and said gate terminal, and/or a Zener diode may be connected between said gate terminal and said second node, and/or a current limiting resistor may be arranged between said gate terminal and said charge pump circuit.

The accompanying drawings are incorporated into the specification and form a part of the specification to illustrate several embodiments of the application. These drawings, together with the description serve to explain the principles of the invention. The drawings are merely for the purpose of illustrating the preferred and alternative examples of how the invention can be made and used, and are not to be as limiting the invention to only the illustrated and described embodiments. Furthermore, several aspects of the embodiments may form—individually or in different combinations—solutions according to the application. The following described embodiments thus can be considered either alone or in an arbitrary combination thereof. Further features and advantages will become apparent from the following more particular description of the various embodiments of the invention, as illustrated in the accompanying drawings, in which like references refer to like elements, and wherein:

### BRIEF DESCRIPTION OF THE DRAWINGS

FIG. 1 is a schematic representation of a power factor correction circuit according to the application;

FIG. 2 is a block diagram of an inrush limiting device according to the application;

FIG. 3 is a schematic circuit diagram of an exemplary power factor correction circuit according to the application.

### DETAILED DESCRIPTION

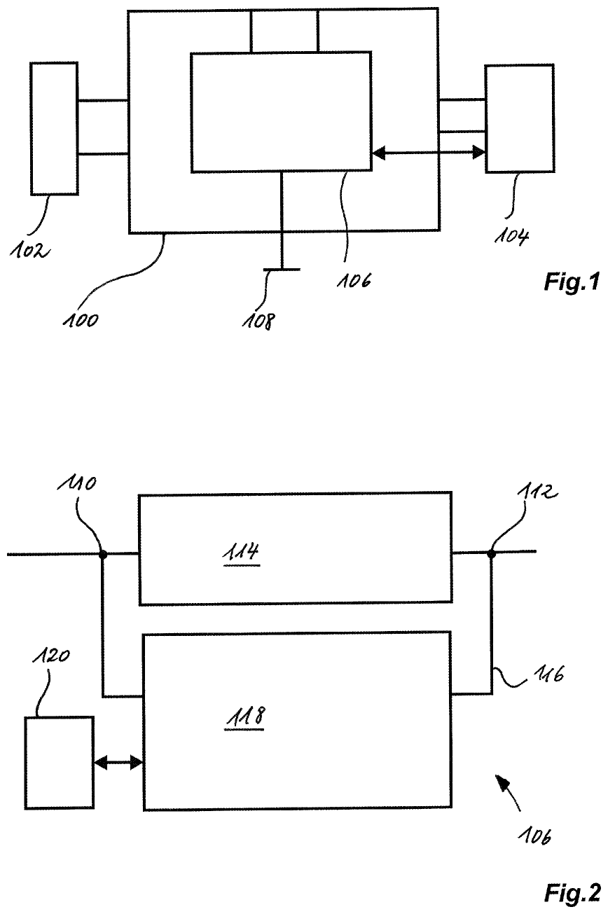

Embodiments will now be explained in more detail with reference to the Figures and firstly referring to FIG. 1. FIG. 1 shows a block diagram of a power factor correction (PFC) circuit 100 according to the application.

The PFC circuit 100 is connected between a power source 102, such as a common AC source, and a load 104. The load 104 may for instance include a lamp, but may of course be any other load. The PFC circuit 100 includes an inrush current limiting device 106. The inrush current limiting device 106 is connected to ground 108 and is also connected to the load 104. As this is known to a person skilled in the art, the PFC circuit 100 performs a power factor correction and, furthermore, the inrush current limiting device 106 avoids detrimental current surges affecting the load 104.

FIG. 2 shows the inrush current limiting device 106 according to the application in more detail. The inrush current limiting device 106 includes a first node 110 and a second node 112. For limiting surge currents, a resistive limiter unit 114 is connected between the first node 110 and the second node 112. The resistive limiter unit 114 may for instance be formed by an NTC thermistor. As already mentioned above, the resistance of negative temperature coefficient (NTC) thermistors falls as their temperature rises. In the cold state, the high initial resistance of the inrush current limiter unit 114 effectively absorbs the power of peak inrush currents between the first node 110 and the second node 112. As a result of the current load and the subsequent heating, the resistance of the limiter unit 114 then drops by a factor >30-50 to a few percent of its value at room temperature. However, the resistive limiter unit 114 still represents a significant resistance between the first node 110 and the second node 112.

In order to reduce this resistance between the first node 110 and the second node 112 during normal operation still further, the application provides a bypass path 116 through a controllable bridging device 118, which is connected between the first and second nodes 110, 112 in parallel to the resistive limiter unit 114.

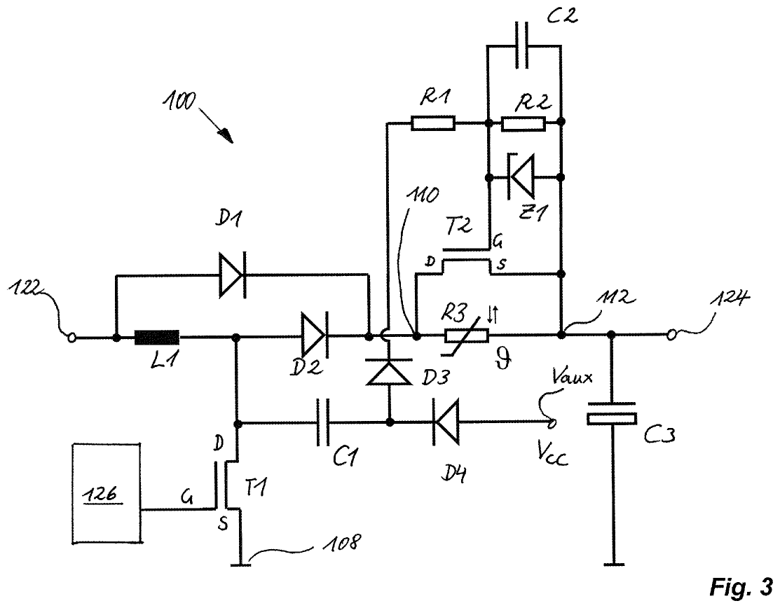

According to the application, the bridging device 118 includes a semiconductor switch, which is controlled by a control unit 120. As will become more apparent from FIG. 3, the control unit includes a charge pump circuit that generates a control of voltage for switching the semiconductor switch.

Advantageously, the bridging device 118 therefore does not need a relay for bridging the resistive limiter unit 114. Consequently, the inrush current limiting device 106 is much smaller than conventional inrush current limiting devices and may even be formed as an SMD component. Moreover, the costs are reduced and no audible sounds, such as clicking or the like occur. The open circuit losses are not deteriorated and the losses during normal operation can be reduced significantly.

FIG. 3 shows a schematic circuit diagram of a PFC circuit 100 according to an exemplary embodiments of the application.

The PFC circuit 100 is a circuit that increases the power factor (PF) by using an electronic circuit with feedback that controls the shape of the drawn current. At an input terminal 122, an input voltage, usually an AC voltage that has passed a rectifying unit, is fed into the PFC circuit 100. At an output terminal 124, the load 104 may be connected. A large filter capacitor C3 is placed between the output terminal 124 and ground for providing a DC voltage to the load.

As this is known to a person skilled in the art, without additional circuitry, once the capacitor C3 is charged to nearly the peak of the rectified input voltage, the power supply would draw power from the line in short pulses only when the instantaneous input voltage exceeds the voltage across the bulk capacitor C3. This produces harmonics whose level can exceed an applicable standard and adversely affect other uses. In order to consume continuous sine-like current over the entire AC cycle, an inductance, a PFC choke L1, is provided. Furthermore, a transistor, for instance a field effect transistor, T1 is provided for controlling the current flow through the PFC choke L1. The PFC switch T1 is controlled by a PFC switch control unit 126 at a frequency much higher than the mains frequency, for instance at frequencies between 30 kHz and 150 kHz.

During an on-time of the PFC transistor T1, the current in the inductor L1 therefore increases. When the switch T1 opens, the voltage across the inductor L1 reverses and it is releasing all or portion of accumulated energy via the diode D2. During the off-time of the switch T1, the inductor current decreases. The net current change during one period depends on the duty cycle of the switch. Hence, the control unit 126 controls the current drawn from the input terminal 122.

Furthermore, an inrush diode D1 is connected in parallel to the PFC choke L1 and the PFC diode D2. For dealing with inrush currents flowing while the bulk capacitor C3 is charged, a resistive limiter unit R3, in particular an NTC thermistor, is provided.

According to the application, the NTC thermistor R3 is bridged by a bypass transistor T2. In other words, when the transistor T2 is switched on, the electrical connection between the first node 110 and the second node 112 is provided by the drain-source channel of the transistor T2 instead of the path via the NTC thermistor R3. The bridging transistor T2 may for instance be a power MOSFET having a very low conduction resistance Rdson of less than 600 mΩ, e. g. 30 mΩ. Consequently, much lower losses occur during operation when the inrush current handling by the NTC thermistor R3 is not needed.

For controlling the bridging transistor T2, a charge pump including a charge pump capacitor C1 and a charge pump diode D3 is connected between the gate terminal of the transistor T2 and the drain terminal of the PFC transistor T1. The charge pump transistor C1 may for instance have a capacitance of 10 nF. The first end of the charge pump transistor C1 is connected to a drain terminal of the PFC switch T1. The second end of the charge pump capacitor C1 is connected via a further diode D4 to an auxiliary voltage Vaux, which may for instance be a positive supply voltage Vcc. The auxiliary voltage Vaux may be any suitable voltage and should have a value between 10 V and 20 V. Advantageously, a supply voltage is used which is present in the integrated circuitry anyway.

By means of this charge pump, a control voltage is generated, which is higher than the bulk voltage at the PFC capacitor C3 by the value of the auxiliary voltage. The control voltage is used to switch the bridging transistor T2, so that the bridging transistor T2 is switched on when the PFC stage is active. Thus, the NTC thermistor is bypassed when the PFC stage is active. On the other hand, the bridging transistor T2 is switched off when the PFC stage is inactive, thereby deactivating the bypassing.

Furthermore, an optional low pass filter formed by a parallel connection of a low pass filter resistor R2 and a low pass filter capacitor C2 is provided between the charge pump and the gate terminal of the bridging transistor T2. Thereby, it can be ensured that the bridging transistor T2 is constantly switched on if the PFC stage is active. The low pass filter resistor R2 may for instance have a resistance of 1 MΩ, and the lower pass filter capacitor C2 may have a capacitance of 1 μF.

For limiting the current through the diode D3, an optional current limiting resistor R1 (having for instance a resistance of 1 kΩ) is arranged between the diode D3 and the gate terminal of the bridging transistor T2. The diodes D3 and D4 should have a rated peak reverse voltage of 600 V.

Moreover, an optional Zener diode Z1 may be provided between the gate terminal of the bridging transistor T2 and the source terminal of the bridging transistor T2 for protecting the transistor T2. The Zener diode Z1 may for instance have a Zener voltage of 20 V.

The PFC circuit 100 according to the application therefore only uses simple electric components for achieving an effective reduction of losses during no-load status as well as during regular operation.

It has to be noted that any values or specific characteristics of the described electric and electronic components are only intended as examples and may of course be varied as necessary in order to adapt the circuitry to the particular needs of a specific application environment. Furthermore, although the embodiments have been described in relation to particular examples, the invention is not limited and numerous alterations to the disclosed embodiments can be made without departing from the scope of this invention. The various embodiments and examples are thus not intended to be limited to the particular forms disclosed. Rather, they include modifications and alternatives falling within the scope of the claims and individual features can be freely combined with each other to obtain further embodiments or examples according to the invention.

REFERENCE NUMERALS

| Reference Numeral | Description |
|---|---|
| 100 | Power factor correction (PFC) circuit |
| 102 | Power source |
| 104 | Load |
| 106 | Inrush current limiting device |
| 108 | Ground |
| 110 | First node |
| 112 | Second node |
| 114 | Limiter unit, NTC thermistor |
| 116 | Bypass path |
| 118 | Bridging device |
| 120 | Control unit |
| 122 | Input terminal |
| 124 | Output terminal |
| 126 | PFC switch control unit |
| C1 | Charge pump capacitor 10 nF |
| C2 | Low pass filter capacitor 1 μF |
| C3 | Bulk capacitor |
| D1 | Inrush diode |
| D2 | PFC diode |
| D3 | Blocking diode 600 V |
| D4 | Blocking diode 600 V |
| L1 | PFC choke |
| R1 | Current limiting resistor 10 kΩ |
| R2 | Low pass filter resistor 1 MΩ |
| R3 | NTC thermistor |
| T1 | PFC FET |
| T2 | Bypass transistor, power MOSFET |
| Z1 | Zener diode 20 V |

1. An inrush current limiting device for limiting inrushing current to a connectable load, the inrush current limiting device comprising:
a first node and a second node,
a resistive limiter unit for limiting current flowing through said limiter unit from said first to said second node, and
a controllable bridging device which is connected between said first and said second nodes in parallel to the limiter unit,
wherein the bridging device includes a semiconductor switch and a charge pump circuit (connected to a control terminal of the semiconductor switch for controlling the semiconductor switch.

2. The inrush current limiting device according to claim 1, wherein the limiter unit includes a resistor with negative temperature coefficient.

3. The inrush current limiting device according to claim 1, wherein said semiconductor switch is a bypass transistor which includes a power MOSFET, wherein a drain terminal of the MOSFET is connected to the first node, a source terminal of the MOSFET is connected to the second node, and a gate terminal of the MOSFET forming said control terminal is connected to said charge pump circuit.

4. The inrush current limiting device according to claim 1, said charge pump circuit including a charge pump capacitor, which is connected with a first end via a first diode to an auxiliary voltage, and is further connected with said first end to the gate terminal of the bypass transistor.

5. The inrush current limiting device according to claim 3, wherein a low pass filter is arranged between said second node and said gate terminal of the bypass transistor.

6. The inrush current limiting device according to claim 3, wherein a current limiting resistor is arranged between said gate terminal of the bypass transistor and said charge pump circuit.

7. The inrush current limiting device according to claim 3, wherein a Zener diode is connected between said gate terminal of the bypass transistor and said second node.

8. A power factor correction, PFC, circuit comprising:
an input terminal which is connectable to a power source,
an output terminal which is connectable to a load,
a PFC choke connected to said input terminal, a PFC diode connected in series with said PFC choke, an inrush diode connected in parallel to the series connection of the PFC choke and the PFC diode, and a PFC switch connected between said PFC choke and a reference potential (108) to form a boost converter, and
an inrush current limiting device, which is connected between said PFC diode and the output terminal,
wherein said inrush current limiting device includes a first node and a second node, a resistive limiter unit for limiting current flowing through said limiter unit from said first to said second node, and a controllable bridging device which is connected between said first and said second nodes in parallel to the limiter unit, wherein the bridging device includes a semiconductor switch and a charge pump circuit connected to a control terminal of the semiconductor switch for controlling the semiconductor switch.

9. The power factor correction circuit according to claim 8, wherein the limiter unit includes a resistor with negative temperature coefficient.

10. The power factor correction circuit according to claim 8, wherein the charge pump is connected between the PFC switch and the PFC choke, and is connected to the bridging device for providing a boosted control voltage.

11. The power factor correction circuit according to claim 8, further including a bulk capacitor connected in series with said limiter unit.

12. The power factor correction circuit according to claim 10, wherein said charge pump is operable to provide a boosted control voltage that equals to a sum of a voltage across said bulk capacitor and a voltage across said PFC switch.

13. The power factor correction circuit according to claim 8, wherein said semiconductor switch is bypass transistor which includes a power MOSFET, wherein a drain terminal of the MOSFET is connected to the first node, a source terminal of the MOSFET is connected to the second node, and a gate terminal of the MOSFET forming said control terminal is connected to said charge pump circuit.

14. The power factor correction circuit according to claim 8, said charge pump circuit including a charge pump capacitor, which is connected with a first end via a first diode to an auxiliary voltage, and is further connected with said first end to the gate terminal of the bypass transistor.

15. The power factor correction circuit according to claim 8, wherein a low pass filter is arranged between said second node and said gate terminal, and/or wherein a Zener diode is connected between said gate terminal and said second node, and/or wherein a current limiting resistor is arranged between said gate terminal and said charge pump circuit.
